(19) United States
(12) Patent Application Publication
(10) Pub. No.: US 2025/0170969 A1
(43) Pub. Date: May 29, 2025

(54) VEHICLE HEADLINER AND METHOD OF MANUFACTURING THE SAME

(71) Applicant: DAEHAN SOLUTION CO., LTD, Incheon (KR)

(72) Inventors: CHOONG HO KWON, SEOUL (KR); YUNGEUN GWAK, INCHEON (KR)

(21) Appl. No.: 18/675,596

(22) Filed: May 28, 2024

(30) Foreign Application Priority Data
Nov. 23, 2023 (KR) KR10-2023-0163991

(51) Int. Cl. B60R 13/02; B32B 1/00; B32B 5/02; B32B 5/18; B32B 5/24; B32B 7/12

(52) U.S. Cl. CPC B60R 13/0225; B32B 1/00; B32B 5/022; B32B 5/18; B32B 5/245; B32B 7/12; B32B 2262/101; B32B 2266/0278; B32B 2307/72; B32B 2605/003

(57) ABSTRACT

The present invention relates to a vehicle headliner and a method of manufacturing the same, in which a substrate is pre-molded into the shape of a headliner, and then rigid or semi-rigid polyurethane is partially foam-molded on a surface of the molded substrate to match the shape and thickness of the headliner, and thus the manufacturing process can be simplified while unintended buzz, squeak and rattle (BSR) and weight can be reduced.

### CROSS-REFERENCE TO RELATED APPLICATION

This application claims priority to and the benefit of Korean Patent Application No. KR 10-2023-0163991, filed on Nov. 23, 2024, the disclosure of which is incorporated herein by reference in its entirety.

### BACKGROUND

### 1. Field of the Invention

The present invention relates to a vehicle headliner and a method of manufacturing the same, and in particular, to a vehicle headliner and a method of manufacturing the same, in which rigid or semi-rigid polyurethane is partially and repeatedly foam-molded on a surface of a substrate pre-molded into a shape of the headliner to match the shape and thickness of the headliner, and thus the headliner can be simply and easily manufactured with a desired rigidity compared to the existing method of manufacturing several layers and bonding them into one.

### 2. Discussion of Related Art

In general, a headliner is mounted inside a vehicle to face a roof panel. The headliner is one of the multi-purpose interior materials that not only enhance the interior design and appearance and effectively reduce noise and vibrations, but also regulate the interior temperature and heat to maintain a constant temperature and protect a driver and passengers in the case of a vehicle accident.

Such headliners are manufactured in a multi-layered structure as described in Patent Documents 1 to 3 below to achieve various effects.

### (Patent Document 1) Korean Registered Patent Publication No. 10-2023-0129080

Patent Document 1 discloses an insulation headliner for vehicles which maximizes the insulation performance of the headliner constituting the ceiling interior of vehicles requiring improved fuel efficiency such as electric vehicles or hybrid vehicles, and a method of manufacturing the same. The disclosed vehicle headliner includes a base layer, a hot melt layer laminated on the base layer, and a vacuum insulation layer laminated on the hot melt layer.

### (Patent Document 2) Korean Registered Patent Publication No. 10-2171526

Patent Document 2 discloses a vehicle headliner and a method of manufacturing the same capable of easy recycling when a vehicle is scrapped by unifying all materials with polypropylene resin, which is a general-purpose resin, and exhibiting low manufacturing costs by simplifying a product structure and a manufacturing process. In addition, the vehicle headliner and method of manufacturing the same of Patent Document 2 realizes sound absorption, heat insulation, heat resistance, environmental friendliness, recyclability, and weight reduction with a simple manufacturing process by applying a non-crosslinked polypropylene foam, which is a thermoplastic resin, without using a thermosetting foam material such as a phenolic resin foam or a polyurethane foam widely used as a conventional headliner material.

### (Patent Document 3) Korean Registered Patent Publication No. 10-1692861

Patent Document 3 discloses a headlining having a heat insulating function for a vehicle, in which a composite layer made of glass fiber and polypropylene (PP) is included among various layers forming the headlining having a multi-layered structure, and a hot melt film containing a heat insulating material is further provided on at least one of both surfaces of the composite layer to block heat introduced into the interior of the vehicle through a roof panel and to provide an effect of reducing the interior temperature of the vehicle even in the middle of summer, and thus the operating time of an air conditioner is reduced, and the fuel efficiency of the vehicle is increased, and a method of manufacturing the same. In addition, Patent Document 3 discloses a headlining having a heat insulating function for a vehicle, in which carbon nanotubes (CNTs) as a heat insulating material are added to provide heat insulation and weight reduction effects and also to simultaneously improve the fuel efficiency of the vehicle, and a method of manufacturing the same. Further, Patent Document 3 discloses a headlining having a heat insulating function for a vehicle, in which a hot melt film having a heat insulating function is attached to both surfaces of the composite layer, or when the headlining is installed in the vehicle, the hot melt film is attached to an outer surface (facing the roof panel) of a polyethylene terephthalate (PET) scrim layer which is closest to the roof panel so that the heat is blocked twice or blocked at a place which is closest to a heat source, and thus the heat insulating effect is further increased, and a method of manufacturing the same.

### RELATED ART DOCUMENTS

### Patent Documents

(Patent Document 1) Korean Registered Patent Publication No. 10-2023-0129080 (Sep. 6, 2023))

(Patent Document 2) Korean Registered Patent Publication No. 10-2171526 (Oct. 23, 2020))

(Patent Document 3) Korean Registered Patent Publication No. 10-1692861 (Dec. 29, 2016))

However, the existing headliners with these multi-layered structures has the following problems.
(1) Since each layer has to be manufactured separately, then assembled, and molded into one part, it takes a long time to assemble a single headliner.
(2) Since each layer has a predetermined thickness, as a result of the multi-layered structure, a high molding pressure is required when manufacturing the headliner, and the failure cost increases due to the problem of not being cut well during cutting.
(3) In addition, the overall thickness of the headliner may become thicker, which reduces the amount of space that can be utilized in a limited interior space.
(4) In addition, since the layers used in multi-layered structures require a high weight to achieve a specific purpose, there is a limit to lightening the headliner.
(5) Meanwhile, the conventional headliner with the rigidity of this multi-layered structure is vulnerable to buzz, squeak, and rattle (BSR), which is unintended noise due to the degree of freedom of accessories when the vehicle is driven, so it is a factor that disturbs the comfortable interior environment.
(6) Finally, due to a complicated space between the headliner and roof panel, it is difficult to manufacture the multi-layered structure to match the shape of the conventional headliner.

### SUMMARY OF THE INVENTION

The present invention is to providing a vehicle headliner and a method of manufacturing the same, in which a substrate is pre-molded into a shape of a headliner, and then rigid or semi-rigid polyurethane is partially and repeatedly foam-molded on the surface of the molded substrate to match the shape and thickness of the headliner so that the manufacturing process can be simplified while unintended buzz, squeak and rattle (BSR) and weight can be reduced.

The present invention is also to providing a vehicle headliner and a method of manufacturing the same, in which a rigid or semi-rigid polyurethane having a density of 10 to 40 kg/m³ is used as polyurethane so that BSR can be improved while the structural rigidity required by the headliner can be reinforced to some extent.

The present invention is also to providing a vehicle headliner and a method of manufacturing the same, in which a glass fiber having a surface density of 20 to 200 g/m² is added to the polyurethane so as to further improve noise performance along with the rigidity reinforcing effect of the polyurethane.

According to an aspect of the present invention, there is provided a method of manufacturing a vehicle headliner, including: forming a substrate (110) including a surface material (110′) and a glass fiber mat (110″) adhered with an adhesive (111) in a shape of a headliner; partially and repeatedly foam-molding a rigid or semi-rigid polyurethane (120) having a density of 10 to 40 kg/m³ on an entire surface of the glass fiber mat (110″) to match the shape and thickness having a tolerance between the headliner and a roof panel when the headliner is mounted on the roof panel so as to form a single piece; and attaching a non-woven fabric (130) to a surface of the polyurethane (120).

Glass fiber having a surface density of 20 to 200 g/m² may be added to the polyurethane (120).

An adhesive (121) may be applied or an adhesive film may be provided between the surface of the glass fiber mat (110″) and the rigid or semi-rigid polyurethane (120).

According to another aspect of the present invention, there is provided a vehicle headliner manufactured by the above described method of manufacturing a vehicle headliner.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a side view showing an vehicle equipped with a headliner according to the present invention;

FIG. 2 is a perspective view exemplary showing a vehicle headliner according to the present invention;

A set of FIG. 3A, FIG. 3B FIG. 3C shows cross-sectional views showing a process of manufacturing a vehicle headliner according to the present invention;

FIG. 4 is a perspective view showing a shape of a headliner formed by foam-molding rigid or semi-rigid polyurethane on a substrate according to the present invention;

FIG. 5 is a perspective view showing the cross-sectional shape of a headliner formed by foam-molding rigid or semi-rigid polyurethane on a substrate according to the present invention;

FIG. 6 is a cross-sectional view showing a layer structure of a vehicle headliner according to a modified example of the present invention; and

FIG. 7 is an image showing a headliner manufactured by the manufacturing method according to the present invention.

### DETAILED DESCRIPTION OF EXEMPLARY EMBODIMENTS

Hereinafter, preferred embodiments of the present invention will be described in detail with reference to the accompanying drawings. Prior to this, terms or words used in this specification and claims should not be construed as limited to their ordinary or dictionary meanings and should be interpreted as meanings and concepts consistent with the technical idea of this invention, based on the principle that the inventor may appropriately define the concept of the term to explain his or her invention in the best way.

Accordingly, it is to be understood that the embodiments described herein and the configurations illustrated in the drawings are only some of the most preferred embodiments of the present invention and are not intended to represent the entire technical idea of the present invention, and that there may be various equivalents and variations that may be substituted therefor at the time of filing this application,

### Headliner Manufacturing Method

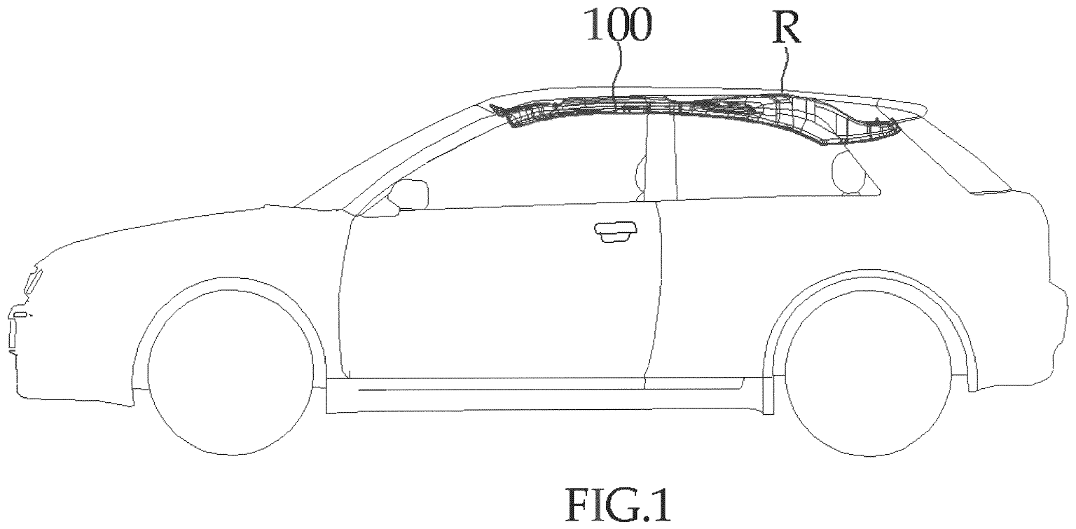

In a method of manufacturing a vehicle headliner 100 according to the present invention, as shown in FIGS. 1 to 6, a substrate 110 is pre-molded into a shape of the headliner 100 and then a rigid or semi-rigid polyurethane 120 having a density of 10 to 40 kg/m³ is partially and repeatedly foam-molded on the substrate 110 to match the shape and thickness of the headliner, and a non-woven fabric 130 is attached on the molded polyurethane to form a single piece so that not only can the process of manufacturing the headliner 100 be significantly simplified, but also the rigidity of the headliner 100 can be secured to some extent through the rigid or semi-rigid polyurethane 120, and in particular, the performance of buzz, squeak, rattle (BSR), which is a noise unintentionally generated when the vehicle is driven, can be improved.

In addition, the polyurethane 120 to which glass fiber having a surface density of 20 to 200 g/m² is added may be used, thereby further improving the noise performance in addition to reinforcing the rigidity of the headliner 100.

Furthermore, an adhesive 121 is applied or an adhesive film is provided between the surface of a glass fiber mat 110″ and the polyurethane 120 so that the substrate 110 and the polyurethane 120 may be firmly attached and integrated.

Hereinafter, this configuration will be described in more detail with reference to the attached drawings. Here, since the manufacturing method according to the present invention is carried out in three steps, each step will be described separately.

### A. First Step

The first step is to form the substrate 110 in a shape of the headliner 100, as shown in FIGS. 1 to 3C

Here, the substrate 110 represents a surface layer of the headliner 100, and in particular, the layer is configured to have a predetermined rigidity, and then pre-molded into the overall shape of the headliner 100 and used.

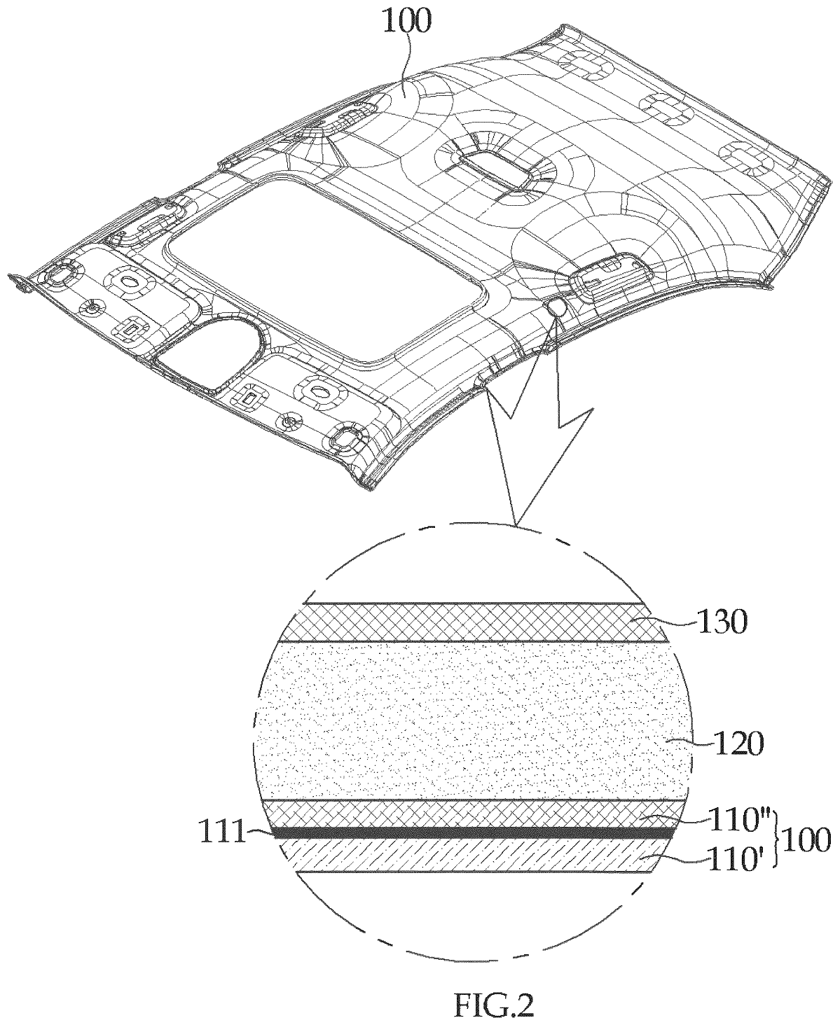

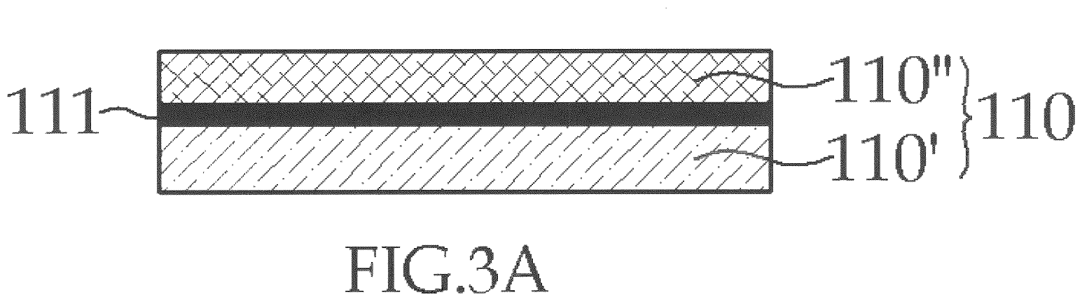

This substrate 110 includes a surface material 110′ and a glass fiber mat 110″, as shown in FIGS. 2 to 3.

### 1. Surface Material

As shown in FIGS. 2 and 3A, the surface material 110′ is exposed to the vehicle interior and is made of cloth, leather, or a material that feels the same or similar to the cloth or leather. Of course, the surface material 110′ may be used by covering the surface of the substrate 110 with another material without being exposed to the interior of the vehicle. This surface material 110′ is integrally formed with the glass fiber mat 110″ through an adhesive 111 such as a hot melt adhesive.

### 2. Glass Fiber Mat

The glass fiber mat 110″ is a mat that is integrally attached to face the surface material 110′, as shown in FIGS. 2 and 3A. In this case, the glass fiber mat 110″ reinforces the rigidity so that the overall shape can be maintained when the substrate 110 is molded into the shape of the headliner 100.

Meanwhile, in a preferred embodiment of this invention, it is preferred that the substrate 110 is introduced into a thermoforming mold and heated to a predetermined temperature while pressure is applied to be molded into the shape of the headliner 100.

Furthermore, in a preferred embodiment of the present invention, components formed in a headliner shape and then mounted on the headliner on the surface of the substrate 110 facing the roof panel, for example, brackets for mounting wiring or lighting devices, and opening brackets are pre-installed on the surface of the substrate 110 and then polyurethane is applied to manufacture the headliner in the second step described below, thereby reducing the process of mounting such components on the headliner, increasing productivity, and improving noise performance.

### B. Second Step

The second step is for foam-molding rigid or semi-rigid polyurethane 120 on the surface of the substrate 110, as shown in FIGS. 2 and 3B.

In this case, the polyurethane 120 is foam-molded using a rigid or semi-rigid polyurethane having a density of 10 to 40 kg/m³ so that the rigidity of the headliner 100 can be sufficiently reinforced and buzz, squeak, and rattle (BSR), which is an unintended noise when the vehicle is driven, can be prevented to provide a comfortable indoor environment.

In addition, in a preferred embodiment of the present invention, as rigid or semi-rigid polyurethane is used as the polyurethane 120, when the polyurethane 120 is foam-molded on the entire surface of the substrate 110 having a relatively large area, there may be difficulties in manufacturing the headliner 100 due to a portion that hardens quickly. Accordingly, the polyurethane 120 is foam-molded on the entire surface of the substrate 110 to match the shape and thickness of the headliner 100, but it is desirable to partially continuously perform the foam molding so that the entire surface of the substrate 110 can be stably foam-molded even when the polyurethane 120 is partially hardened. Here, the “shape and thickness” refers to the shape and thickness excluding a predetermined tolerance between the headliner and roof panel, for example, a tolerance of about 5 mm, when the headliner is mounted on the roof panel. This tolerance not only allows the headliner according to the present invention to be easily assembled to the roof panel, but also prevents noise and abnormal sounds from occurring by preventing the headliner from directly contacting the roof panel.

Of course, the foam molding of the polyurethane 120 is not illustrated in the drawings, but in a preferred embodiment of the present invention, it is possible that a mold is divided into several molds with which the polyurethane 120 can be foam-molded on the entire surface of the substrate 110, and then the divided molds are installed for each area so that the polyurethane 120 may be partially and repeatedly foam-molded. Specifically, the polyurethane 120 may be foam-molded by a foam molding machine including the divided molds that rotate in an endless orbit to match the shape and thickness of the headliner.

In additional, in a preferred embodiment of the present invention, glass fiber having a surface density of 20 to 200 g/m² may be added to the polyurethane 120. This is for obtaining the required rigidity and noise performance of the headliner 100 by adding glass fiber to the polyurethane 120 when sufficient rigidity and noise performance cannot be obtained even when the rigid or semi-rigid polyurethane 120 is foam-molded on the substrate 110.

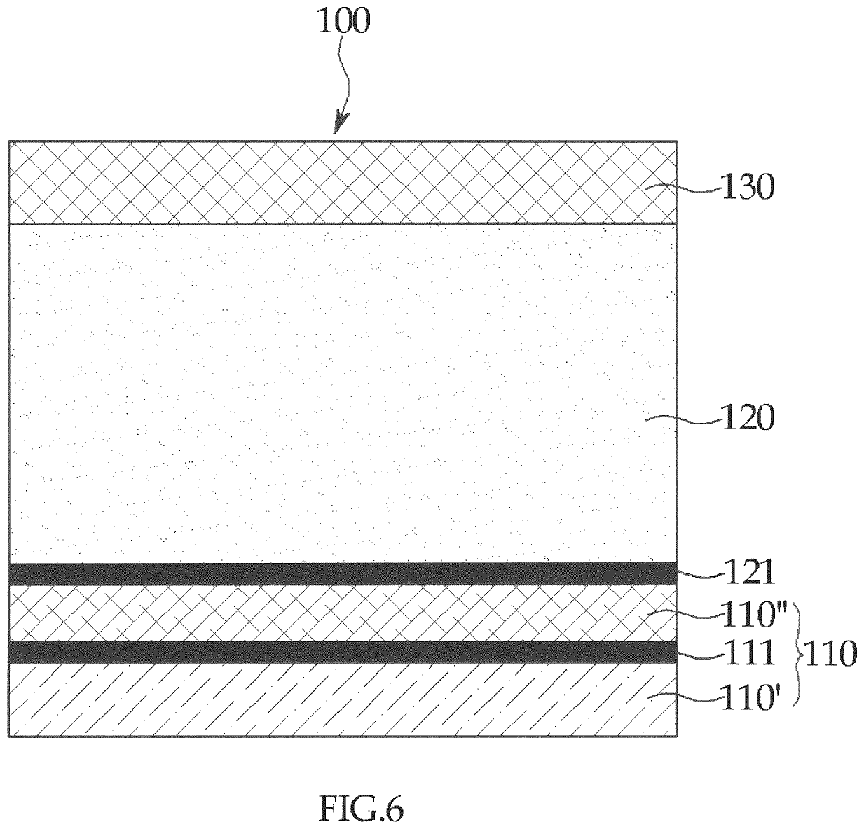

Finally, in a preferred embodiment of the present invention, before the polyurethane 120 is foam-molded on the surface of the substrate 110, it may be manufactured by applying an adhesive 121 such as a hot melt adhesive or inserting an adhesive film on the surface of the substrate 110 as shown in FIG. 6. This is to allow the polyurethane 120 to be foam-molded on the surface of the substrate 110 to be integrally and firmly attached.

### C. Third Step

The third step is a step of attaching the non-woven fabric 130 to the surface of the polyurethane 120, as shown in FIGS. 2 and 3C. The non-woven fabric 130 supports the headliner 100 so that it does not tear easily, but also does not deform and retains its shape. This non-woven fabric 130 may be attached using an adhesive such as a hot melt adhesive or may be integrally attached by partially attaching together when the polyurethane is foam-molded.

The present invention, which is described above, not only makes it easy and convenient to manufacture a headliner through a simple process of foam-molding rigid or semi-rigid polyurethane on a substrate molded in a shape of a headliner, but also makes it possible to supplement sufficient noise performance and rigidity by performing foam molding the polyurethane to match the shape and thickness of the headliner.

### Headliner

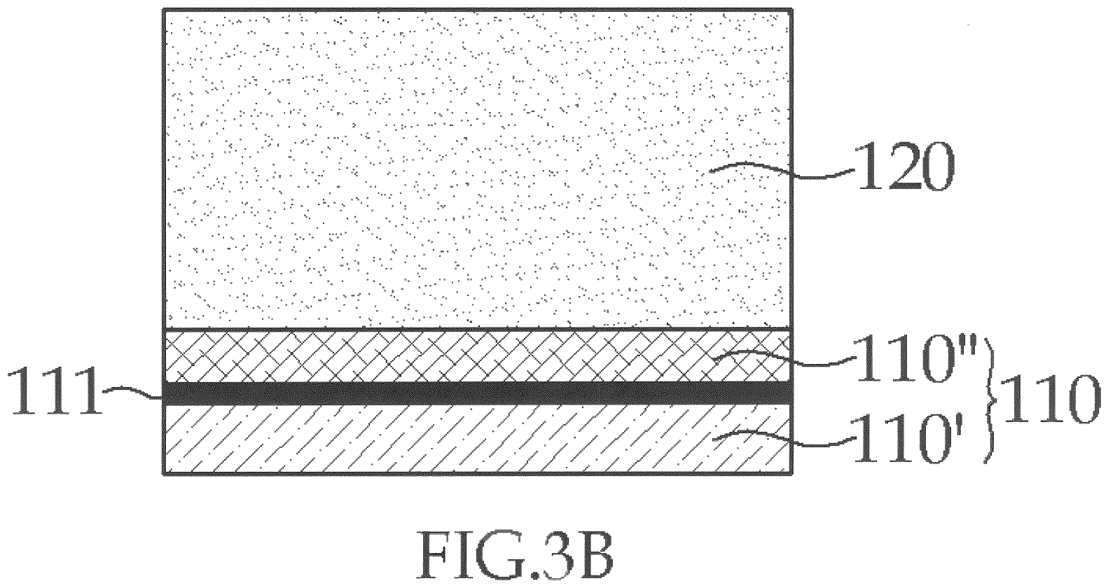

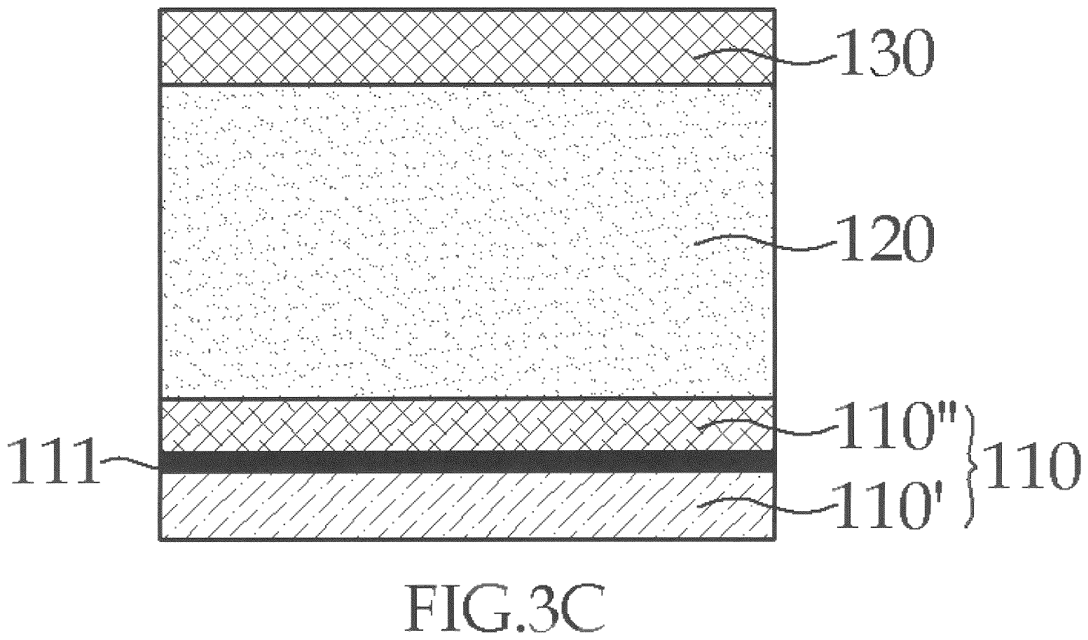

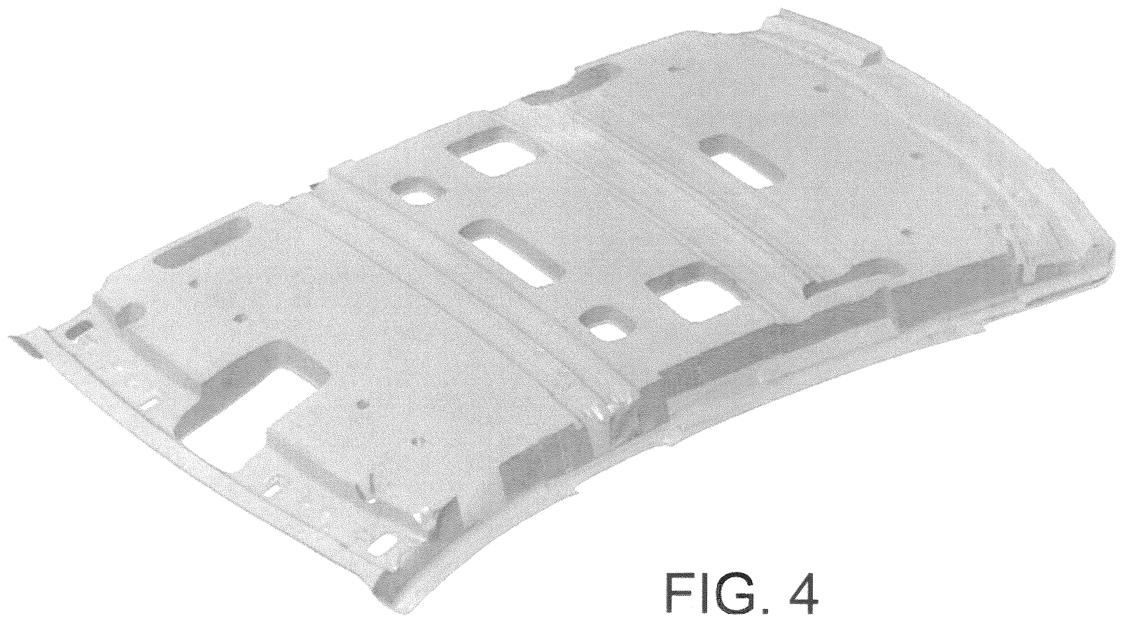

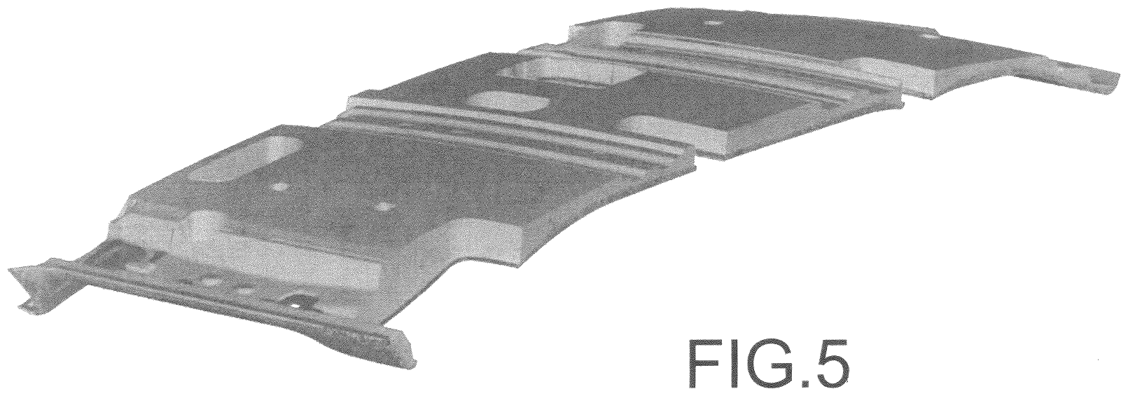

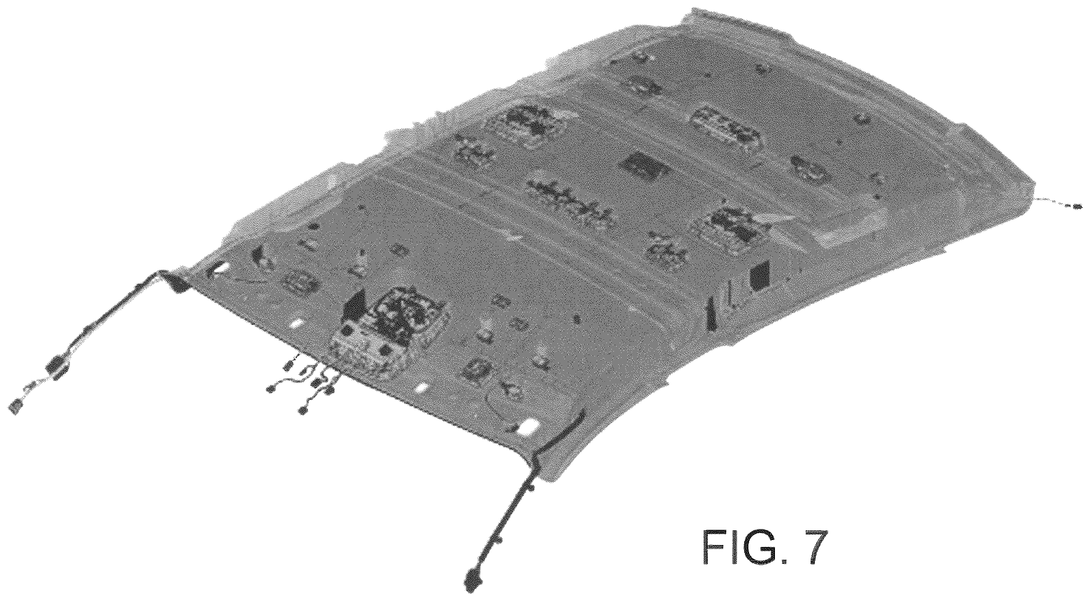

As shown in FIGS. 4 and 5, the present invention includes a vehicle headliner manufactured by the above-described vehicle headliner manufacturing method, and FIG. 7 is an image showing a vehicle headliner manufactured by the above-described vehicle headliner manufacturing method.

A vehicle headliner and a method of manufacturing the same according to the present invention have the following effects.
(1) Since polyurethane is foam-molded on a substrate surface pre-molded into a shape of a headliner to match the shape and thickness of the headliner, and then a non-woven fabric is attached to complete the molding of the headliner, a layer structure constituting the headliner can be simplified and the headliner can be simply manufactured.
(2) In this case, since a rigid or semi-rigid polyurethane having a density of 10 to 40 kg/m³ is used, the polyurethane is partially foam-molded on the surface of the substrate to be molded into a desired shape and thickness, and thus the polyurethane, which is cured in a short time, can be stably foam-molded, and buzz, squeal and rattle (BSR), which is an unintended noise while the vehicle is driven, can be improved.
(3) In addition, as a glass fiber having a surface density of 20 to 200 g/m² is added to the polyurethane and the polyurethane is foam-molded, the structural rigidity of the headliner can be reinforced and noise performance can also be improved.
(4) Further, since the polyurethane is foam-molded on the surface of the substrate which is coated with a hot melt adhesive or on which a hot melt film is inserted, as the hot melt adhesive or the hot melt film is firmly attached between the substrate and the polyurethane, it is possible to manufacture a headliner having further enhanced rigidity.
(5) Meanwhile, since a foam molding thickness of polyurethane can be easily adjusted, it can be conveniently and safely used by simply performing foam molding to match the desired shape and thickness for the desired portion.
(6) In addition, even when the headliner and the roof panel has an inconstant gap therebetween and a complex shape, it can be manufactured to correspond thereto, and thus the desired rigidity and noise performance can be sufficiently obtained.
(7) Finally, components installed on the surface of the headliner facing the roof panel, such as brackets for mounting wiring or lighting devices, opening brackets, etc., are pre-installed and then polyurethane is applied to manufacture the headliner so that the process of installing the components on the headliner can be simplified to increase the productivity, and the components can be more securely attached to improve noise performance.

What is claimed is:

1. A method of manufacturing a vehicle headliner, comprising:
forming a substrate (110) including a surface material (110′) and a glass fiber mat (110″) adhered with an adhesive (111) in a shape of a headliner;
partially and repeatedly foam-molding a rigid or semi-rigid polyurethane (120) having a density of 10 to 40 kg/m³ on an entire surface of the glass fiber mat (110″) to match the shape and thickness having a tolerance between the headliner and a roof panel when the headliner is mounted on the roof panel so as to form a single piece: and
attaching a non-woven fabric (130) to a surface of the polyurethane (120).

2. The method of claim 1, wherein a glass fiber having a surface density of 20to 200 g/m² is added to the polyurethane (120).

3. The method of claim 1, wherein an adhesive (121) is applied or an adhesive film is provided between the surface of the glass fiber mat (110″) and the rigid or semi-rigid polyurethane (120).

4. The method of claim 1, wherein, in the forming of the substrate (110), after the substrate (110) is molded into the shape of the headliner, a component to be mounted on the headliner is pre-installed on a surface of the substrate (110) facing the roof panel.

5. A vehicle headliner manufactured by the method of claim 1.

6. A vehicle headliner manufactured by the method of claim 2.

7. A vehicle headliner manufactured by the method of claim 3.

8. A vehicle headliner manufactured by the method of claim 4.
